(19) United States
(12) Patent Application Publication
(10) Pub. No.: US 2025/0379643 A1
(43) Pub. Date: Dec. 11, 2025

(54) CELLULAR NETWORK REPEATER WITH FAILOVER FUNCTION

(71) Applicant: Airgain, Inc., San Diego, CA (US)

(72) Inventors: Chen-Yuan Chin, San Diego, CA (US); Shenjie Miao, San Diego, MN (US); Ali Sadri, San Diego, CA (US)

(21) Appl. No.: 19/211,768

(22) Filed: May 19, 2025

Related U.S. Application Data
(60) Provisional application No. 63/649,716, filed on May 20, 2024.

(51) Int. Cl. H04B 7/155; H04B 1/38; H04B 17/309; H04W 16/28

(52) U.S. Cl. CPC H04B 7/15507; H04B 1/38; H04B 17/309; H04W 16/28

(57) ABSTRACT

A beamforming, antenna system of a radio repeater is coupled to communicate with a first serving sector of a first base station. A radio transceiver relays signals between the first serving sector and a terminal device. A processor is coupled to the radio transceiver and operable to receive a signal to change from the first serving sector. The processor steers the antenna system to determine performance indicators of surrounding base stations detectable by the radio repeater. The processor determines a second serving sector different from the first serving sector based on a comparison of the performance indicators. Signals are relayed between the second serving sector and the terminal device, e.g., by reconfiguring the transceiver.

This application claims the benefit of U.S. Provisional Application No. 63/649,716, filed May 20, 2024, the entire content of which is hereby incorporated by reference.

### SUMMARY

This application relates generally to radio repeaters used in cellular data networks. In one embodiment, a radio repeater includes a beamforming, antenna system coupled to communicate with a first serving sector of a first base station. A radio transceiver is operatively coupled to the antenna system and is operable to relay signals between the first serving sector and a terminal device. A processor is coupled to the radio transceiver and operable to receive a signal to change from the first serving sector. The processor steers the antenna system to determine performance indicators of surrounding base stations detectable by the radio repeater. The processor determines a second serving sector different from the first serving sector based on a comparison of the performance indicators. Signals are relayed between the second serving sector and the terminal device, e.g., by reconfiguring the transceiver.

In another embodiment, a method involves repeating first wireless signals between a first serving sector of a first base station and a terminal device via a radio repeater. A signal is received at the radio repeater to change from the first serving sector. A beamforming antenna system of the radio repeater is steered to determine performance indicators of surrounding base stations detectable by the radio repeater. A second serving sector different from the first serving sector is determined based on a comparison of the performance indicators. The radio repeater is reconfigured to repeat signals between the second serving sector and the terminal device.

The figures and the detailed description below more particularly exemplify illustrative embodiments.

### BRIEF DESCRIPTION OF THE DRAWINGS

The discussion below makes reference to the following figures.

FIGS. 1-4 are block diagrams of a cellular system according to an example embodiment;

FIG. 5 is a sequence diagram showing a failover process according to various example embodiments;

FIGS. 6, 7A, and 7B are tables illustrating performance indicators and other data used in failover processes according to example embodiments;

FIG. 8 is a block diagram of a repeater apparatus according to an example embodiment;

FIGS. 9 and 10 are flowcharts of methods according to example embodiments.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to cellular data networks. Cellular networks have been around since the 1970′s, which then offered wireless analog telephone service. Cellular networks have evolved in both ubiquity and capability since then. Most modern cellular networks support packet switched digital networks that extend the wired Internet infrastructure to the wireless domain. Cellular networks are considered wide area networks (WAN) and/or global area networks (GAN). The latest cellular network standards are fifth generation (5G), although older infrastructure (e.g., LTE, 4G, 3G, etc.) is still in use and 6G networks are in development. The latest 5G networks offer faster speeds, lower latency, and the ability to connect more devices simultaneously compared to earlier standards.

Mobile devices (e.g., smartphones, tablets) are the most common end-user network device (also referred to herein as a terminal device or user terminal) that use cellular networks. As the cost and capabilities of cellular networks have improved, other devices have also utilized cellular networks such as home gateways, vehicle infotainment system, autonomous vehicles, remote monitoring equipment, etc. For some of these applications, a loss of connectivity can be more than just a temporary annoyance, it can lead to a complete loss of functionality. Therefore, network infrastructure that can ensure maximum coverage will become more valuable as terminal devices become more ubiquitous.

Typically, terminal devices connect to base stations, sometimes referred to as cell towers. Base stations include radios that transmit and receive cellular signals to and from terminal devices. They are typically placed strategically to provide coverage over a specific area or cell. A backhaul network infrastructure connects the base stations to the core network of the cellular operator, e.g., via wired (fiber optic, copper) and wireless (microwave, satellite) links. A core network includes a central part of the infrastructure that manages communications between mobile devices, base stations, and external networks (like the Internet). The core network includes components such as Mobile Switching Centers (MSCs), Home Location Registers (HLRs), and Gateway GPRS Support Nodes (GGSNs).

Wireless network connectivity can be lost due to geography, e.g., where features of a landscape or cityscape cause a blind spot or a coverage hole in a cellular network. In such a case, even if a terminal device is within a maximum transmission distance of a base station, a reliable connection sometimes cannot be made due to large structures (e.g., hills, trees, buildings) that block the line of sight of the tower or multipath interference from structures that aren't necessarily in direct line of sight between the terminal device and base station. These phenomena can be frequency dependent, e.g., may be pronounced at frequencies above 1 GHz.

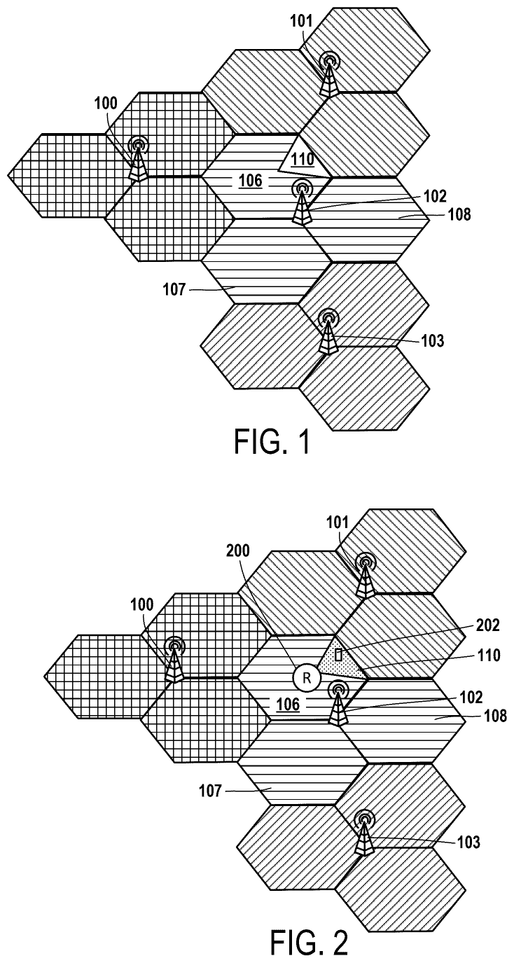

In FIG. 1, a diagram illustrates a network arrangement in which a repeater device according to various embodiments may be deployed. A number of base stations 100, 101, 102, and 103 are shown that provide coverage to particular cells or regions, shown here as corresponding to hexagonal cell planning. The hatching of the hexagons in the drawing indicates multiple regions are covered by a single base station. For example, cells 106, 107, and 108 are drawn with horizontal hatching, indicating they are commonly covered by base station 102. When a base station covers multiple cells, each cell is serviced by a part of the base station which may be referred to as a serving sector. In this figure, each base station 100-103 has three serving sectors. Each serving sector may be handled by three different radio communications sections (e.g., antenna, transceiver) within the base station. Thus a base station may experience a partial failure that affects only one of its serving sectors. In other cases, a failure affecting the entire base station, such as primary and backup power loss, may affect all of the serving sectors of the base station.

As indicated by triangular region 110 in FIG. 1, blind spot or coverage hole may be observed in the cellular network. The mobile network operator may have a few options to deal with this, such as a small cell base station or a repeater. A repeater has some advantages, such as reducing capital and operational expenses. In FIG. 2, a repeater 200 is shown deployed to regain the coverage area 110, which is drawn with shading to indicate coverage repeater. Even if the region 110 may have marginally acceptable radio reception, the repeater 200 may be deployed, e.g., for end users that require high-quality and/or high-availability cellular radio service.

Generally, the repeater 200 is a device that relays signals between the base station's serving sector and a terminal device 202. For purposes of this example, reference numeral 106 is used here to annotate both the cellular region and the serving sector of the base station 102 that services the cellular region. The repeater 200 receives signals from the serving sector 106 of the base station 102 and retransmits the signals to the terminal device 202. This also involves receives signals from the terminal device 202 and retransmitting the signals to the serving sector 106 of the base station 102. The repeater 200 may selectively retransmit signals between the serving sector 106 at the terminal device 202, e.g., within a frequency range.

Generally, the radio and processing sections of the repeater that communicate with the service sector 106 are referred to herein as a donor unit (DU), and the radio and processing sections that communicate with the terminal device 202 are referred to as a repeater unit (RU). Thus the antenna of the repeater 200 that communicates with the base station 102 is referred to as a donor antenna, and the antenna that communicates with the terminal device 202 is referred to as a repeater antenna. The donor and repeater sections may share some components, and this designation is provided for purposes of illustration and not limitation.

The repeater 200 may be managed or unmanaged. An unmanaged repeater typically includes a local interface (e.g., serial port, WiFi access point) that allows configuring the device, which thereafter runs without operator input. A managed repeater may include the local interface as well as a network management interface that allows remote access via a WAN. This interface may include an Internet of Things (IoT) modem that provides network access via the cellular network. A software component (e.g., a web server) runs inside the repeater that handles tasks such as managing connections, providing user interface data (e.g., HTML), reading and writing internal state, etc.

As long as the repeater 200 is properly configured to connect to the donor unit (serving sector 106), it will provide cellular service in the coverage area 110, e.g., acting as a proxy for serving sector 106 of the base station 102. However, the serving sector 106 of base station 102 may experience unexpected or expected downtime and the donor unit will lose source leading to disconnection of the repeater 200 from the coverage area 110.

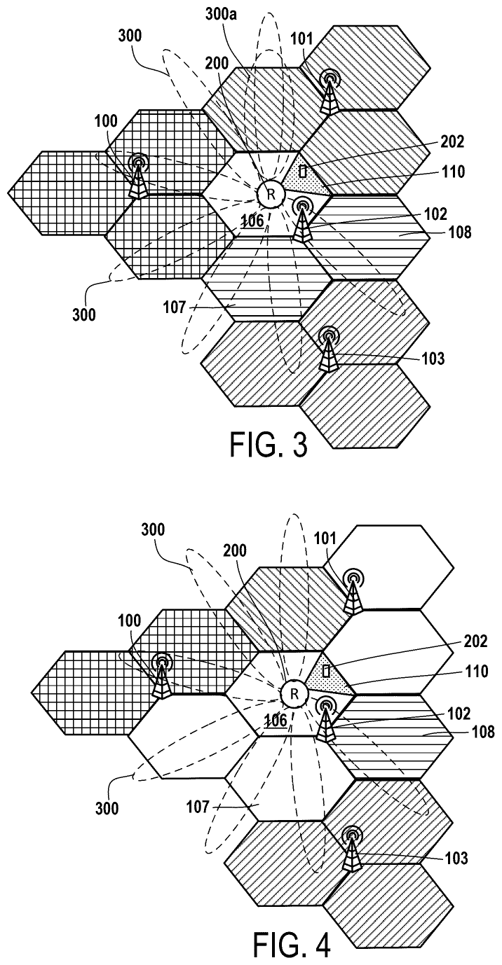

In FIGS. 3 and 4, diagrams illustrate scenarios in which the repeater 200 may experience loss of signal at the donor unit. In FIG. 3, the single serving sector 106 has gone down (e.g., partial failure of base station 102) and in FIG. 4 multiple serving sectors have gone down, associated with multiple base stations 100, 101, and 102. In one embodiments, loss of the serving sector 106 currently being used as a donor by the repeater 200 is signaled to the repeater 200 either inherently (e.g., detection via the repeater 200) or expressly (e.g., message sent to the repeater 200 via a network). The loss of signal in from the serving sector 106 is only one example of a situation where the repeater 200 is commanded to change from the serving sector 106. Other examples may include a predicted future failure, network congestion, equipment upgrades, etc.

An example of inherent signaling is full or partial loss of signal from the base station 102 that is providing the serving sector 106. This can be based on factors such as signal strength below a threshold level, time that signal is low or missing, etc. If the repeater 200 is capable of reading data traffic and/or status messages from the base station 102, this may provide other inherent reasons to change from the serving sector 106 (e.g., radio sections are fully operational, but backhaul connection is lost). An example of express signaling is a message sent over the network management interface informing the repeater 200 of the outage. This message may originate from a human operator and/or a software component that automatically detects conditions and sends the appropriate messages.

In response to receiving the signal to change from the serving sector 106, the repeater 200 steers the donor antenna to determine performance indicators of surrounding base stations detectable by the repeater 200. The steering of the donor antenna is indicated by the dashed ovals 300. Beam-forming type steering is often employed to deal with the quasi-optic nature of 5G frequencies. This steering may involve selecting different antennas and/or changing inputs to one or more phased array antennas. Generally, the directionality and sensitivity (e.g., the shape of the ovals 300) of a phased array antenna can be changed by switching antenna elements and changing a relative phases of signals transmitted or received via the antenna. An example of a change in sensitivity of the antenna element is indicated by oval 300a, which is more broad than ovals 300, but with lower peak sensitivity. The antennas may be able to make multiple passes with different sensitivity/coverage settings.

In some cases, the repeater 200 may have multiple antenna ports, e.g., for multiple-input, multiple-output (MIMO) arrangement. In such a configuration, the different antenna ports may scan portions of the region in parallel (e.g., MIMO_1 scan and MIMO 2 scan) which reduces the time to acquire the performance indicators. It is also possible for each port to have multi-beams. For example, a quad multiplexer may be used for frequency components f1, f2, f3, f4 on each port, thus the port will have four beams (PortA Beam 1 <>f1, etc.). Note that the scanning operation will work with other types of antenna access, e.g., single-input, single-output (SISO), which may also have multiple access ports.

The repeater 200 performs at least one scan of surrounding base stations, and this may include the base station 102 that provided the serving sector 106 that is being changed. This need not be a full 360° scan. As seen in the drawing, a region corresponding to the coverage area 110 may be skipped to prevent interference and/or because it may be assumed that there are no promising candidate base stations in the region 110 due to the use of the repeater 200 to provide service there. The scanning of the surrounding base stations will gather a data set that can be stored at least temporarily on the repeater 200 an/or some other element, e.g., in the backhaul network, in the core network, etc.

The data obtained by the scan is analyzed to determine a second serving sector different from the serving sector 106 based on a comparison of the performance indicators. The performance indicators are obtained by the repeater 200 and may be augmented by data not generally available to the repeater 200, e.g., data available at the core network regarding the configurations and states of the various base stations 100-103. After the second serving sector is chosen (e.g., serving sector 108 for example), the repeater 200 will subsequent relay signals between the second serving sector 108 and the terminal device 202. This may involve changing radio settings for reception and transmission to optimize performance when using the second serving sector 108, and may also involve changing data at a higher level in the network stack, e.g., a change in the cellular ID used by the terminal 202 to correspond to that of serving sector 108 instead of serving sector 106. This type of change may be handled by the terminal 202 and base station 102 as a routine handover/handoff operation.

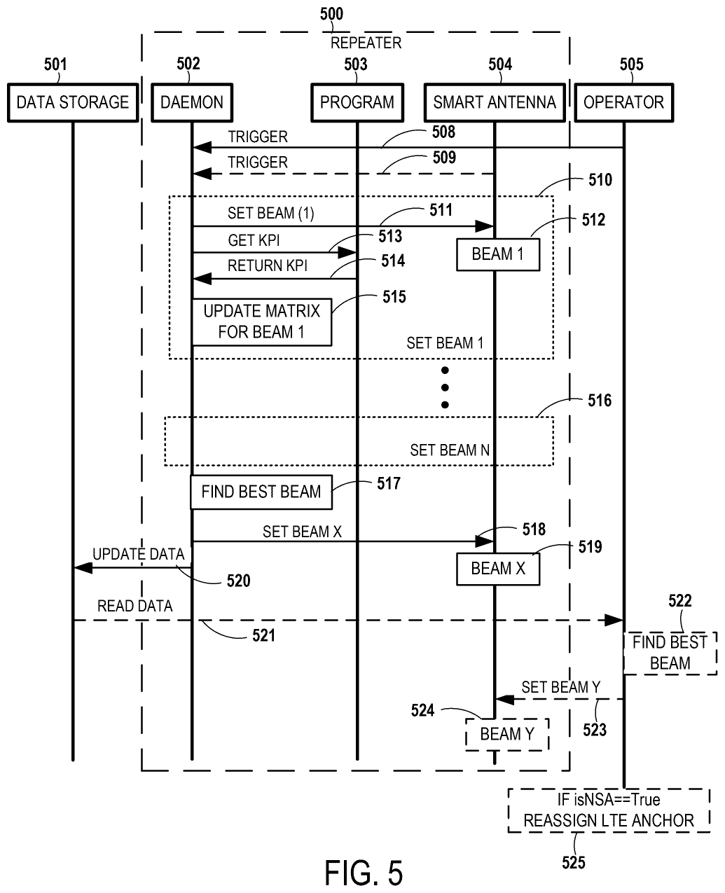

In FIG. 5, a sequence diagram shows an interaction between a repeater 500 and other components of a system according to an example embodiment. Volatile or non-volatile data storage 501 is shown that may be part of the repeater 500 or, as shown, external to and accessible by the repeater 500. The repeater 500 includes computing hardware (e.g., a processor, a system on a chip) and an antenna system, as indicated by smart antenna 504. A daemon 502 runs on the computing hardware of the repeater. The daemon 502 is a process that runs continually in the background to provide various functions of the repeater 500.

A program 503 provides access to specific functions or hardware, such as the smart antenna 504 in this example. An operator station 505 represents an infrastructure control element that may represent a human operator and/or an automated server processes. The operator station 505 can access a network management interface (not shown) of the repeater 500 via the Internet and/or the operator network. The operator station 505 can also access the data storage 501, e.g., via a management interface on the repeater 500, via a storage interface on an intermediate component (e.g., backhaul network) and/or via a local interface directly accessible via hardware (e.g., server, terminal) of the operator station 505, such as a data center storage interface.

At the start of the illustrated sequence, a donor antenna of the radio repeater 500 is coupled to communicate with a first serving sector of a first base station, e.g., providing service to terminal devices in a coverage area of the repeater 500. As indicated by trigger signals 508, 509, the repeater receives a signal to change from the first serving sector, which involves finding another service sector which it can use to provide service to terminals in the repeater's coverage are. This changing of serving sectors is generally referred to as a failover, although this need not be due to a failure that occurs in the first serving sector.

Note that trigger signal 508 originates from the operator station 505, which may be due to a human input and/or and algorithmic determination. The trigger signal 508 may be due to a failure of the first serving sector, a predicted or detected quality issue at the first serving sector, a time consuming reconfiguration of the serving sector, etc. In contrast, trigger signal 509 (which is shown in dashed lines indicating it is an alternative to signal 508) originates from the antenna 504, meaning it may be a failure or degradation detected by the repeater 500 itself. The operator may want to limit some aspects of automatic failover by the repeater 500, e.g., to prevent intermittent conditions from triggering multiple failovers in s short amount of time. Still, there may be an event or condition that makes it advantageous for the repeater 500 to make its own failover decisions, e.g., it can respond quickly to a detected condition or event. The repeater 500 may be configured to limit “churning” of failovers, e.g., waiting a timeout before failover is executed, limiting a number of times the failover may be automatically triggered within a time period.

As indicated by box 510, the repeater 500 performs a repeated process involving steering the beam 511, 512, determining 513, 514 performance indicators (herein denoted as key performance indicators or KPI), and updating 515 a data structure (referred to in the figure as a matrix) to include the performance indicators. This process is repeated multiple times, as indicated by the ellipsis between boxes 510 and 516. The result is that the updated matrix will include a set of performance indicators of surrounding base stations detectable by the radio repeater 500. This can be used by a selection algorithm, as indicated in block 517.

Block 517 indicates a best beam is found, which correlates to a second serving sector of the same or different base station. This search for a new serving sector involves a comparison of the performance indicators. This may involve optimization, e.g., to find highest signal strength, lowest noise, or the like. The optimization may be based on one performance indicator, or multiple performance indicators may be jointly optimized. The determination of “best beam” may not require optimization in some cases. For example, the repeater 500 may have a predefined order of fallback serving sectors. These fallbacks may be defined by a stored list or based on some other factor, e.g., sorting of cell identifiers. Thus if a serving sector is at the top of this list and its performance indicators meet some minimum standard, then it could be chosen as the new serving sector even though sectors with better performance may have been detected.

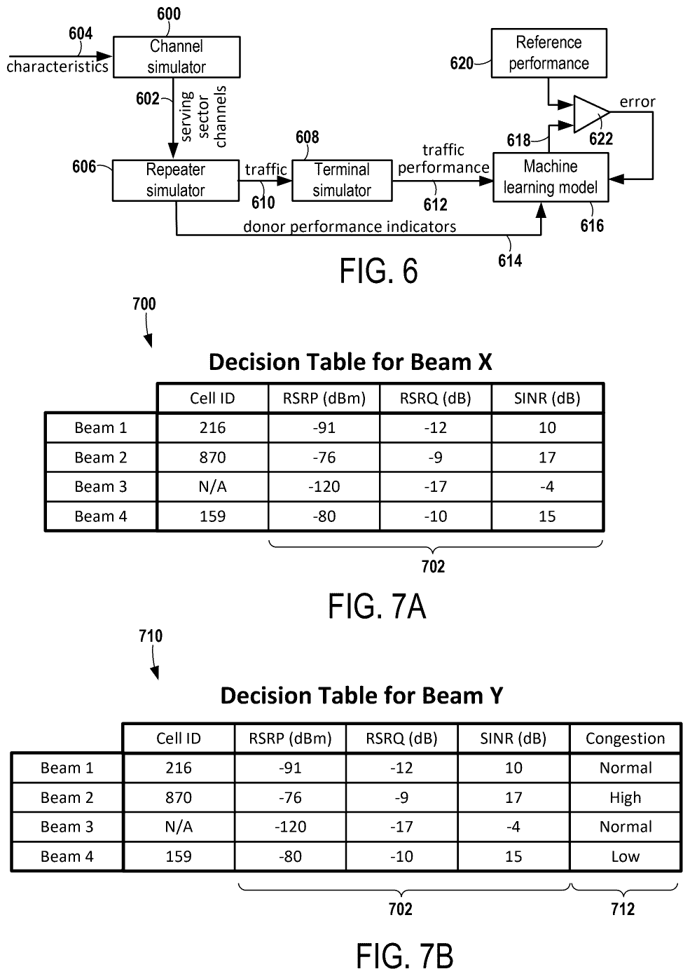

In other embodiments, the selection algorithm 517 may use an artificial intelligence and/or machine learning model to select the best beam. While similar to optimization, this may not require explicitly ranking, analyzing, or otherwise characterizing the performance indicators. In some cases, an artificial intelligence algorithm may utilize a search (e.g., greedy search) of a state space formed by the performance indicators to find a best beam. In other embodiments, a machine learning model can be formed utilizing a real or simulated set of performance indicators and a real or simulated repeater. In FIG. 6, a block diagram shows formation of a machine learning model according to an example embodiment.

In this example, simulated radio transmission channels 602 could be used as training inputs to a radio repeater simulation model. The simulated serving sector channels 602 could be estimated by a channel simulator 600 based on a realistic radio channel characteristics 604 (e.g., noise, transmitting power, channel attenuation, multipath interference, transmission/reception angle) and then simulates how data over the different channels 602 may be received at a repeater simulator 606.

The training sessions with the repeater simulator 606 could use a number of different types of data traffic 610 (e.g., voice call data, streaming video, web traffic, file downloads) through the simulated repeater 606. A simulated terminal device 608 could gather a number of traffic performance indicators 612, such as dropped packets, quality of service, maximum upload/download bandwidth, etc. The simulated repeater 606 also provides donor unit performance indicators 614 similar to those gathered by a real repeater. This indicators 614, together with traffic performance indicators 612 can be used as input vectors to a machine model 616 (e.g., a neural network, hidden Markov model, state vector machine) and the outputs 618 could be compared to some optimal or acceptable traffic performance vectors 620.

By utilizing an error function 622 and iterative correction of model variables (e.g., backpropagation), the network can be trained to classify a set of real-world performance indicators (e.g., as shown in data sets of FIGS. 7A and 7B). For example, an output of a neural network could, for each vector of performance indictors input to the network, provide a ranking for each vector. The ranking predicts which will provide the best traffic performance for a terminal device. Other data (e.g., global/network data, not shown) could also be used in training the machine learning model 616 to provide an augmented ranking based on data that is unavailable to the repeater.

Once trained, the machine learning model 616 includes data (e.g., neural network weights, node probabilities) that can be transferred to the memory of a repeater device. After a scan as shown in FIG. 5, the repeater device inputs measured performance indicators into the machine learning model 616, which provides an output (e.g., ranking of each beam) that guides beam selection and use of a new serving sector. The machine learning model 616 could also or instead be deployed to the operator station, where it may be adapted to utilize other data described below (e.g., global data). Different machine learning models could be developed for different repeater models, different network types (e.g., 4G, 5G), different data traffic types, etc.

In reference again to FIG. 5, once a second serving sector different from the first serving sector is determined at block 517 (e.g., using an algorithm or machine learning model as described above), then the repeater 500 is reconfigured to relay signals between the second serving sector and the terminal device. This is indicated by blocks 518, 519, which involve setting the beamforming antenna to point to the newly selected serving sector, and to make other internal state changes. The repeater 500 updates 520 a data structure at the data storage 501 which indicates not only the selected serving sector but the entire data structure (matrix) which includes the performance indicators of all the serving sectors scanned in blocks 510 through 516.

As indicated by operations 521-524, the operator station 505 can read the stored data from the data storage 501 and perform a separate search 522 for another beam/serving sector, which is sets 523, 524 a third serving sector different than the second serving sector, which was set at operation 518. The operator station 505 can use other data (e.g., global data, network data, and/or other data that may not unavailable to the repeater 500). Examples of this data are shown below in FIGS. 7A and 7B. In some cases, the search/selection 522 may involve displaying the other data and the operational indicators on a display, and receiving an input (e.g., mouse, keyboard, touch screen) indicating an operator selection of Beam Y, which triggers command 523.

Note that the operations 521-524 are optional (drawn in dashed lines) and if implemented, may supersede operations 517-519. In other words, operations 517-519 may be optional in some embodiments, the repeater relying instead on operations 520-524 to change the serving sector. Also note that this process can be applied to numerous cellular technologies (e.g., 3G, LTE, 5G, 6G). In a 5G, non-standalone (NSA) mode, the operator station 505 will also reassign 525 the long-term evolution (LTE) anchor to the new 5G beam set at operation 524.

In FIG. 7A, a table 700 illustrates an example of performance indicators that can be gathered by a radio repeater according to an example embodiment. This table 700 includes four different beam settings by way of example, and the performance indicators 702 include reference signal receive power (RSRP), reference signal receive quality (RSRQ), and signal to interference and noise ratio (SINR). The latter is similar or equivalent to signal to noise ratio (SNR). The performance indicators 702 can be read via a steerable donor antenna, and processed via a preamplifier and other signal processing components of the repeater. In the example of FIG. 5, the repeater 500 might choose Beam X, X=2, as this has the best signal quality based on every indicator.

In FIG. 7B, a table 710 illustrates an example of data that can be gathered by an operator according to an example embodiment. The data includes the performance indicators 702 gathered by the radio repeater along with other data 712 that can be gathered by a network control element. The other data 712 may be considered network state data, global data, operator data, etc., Generally, the repeater may not be configured to gather this other data 712 as there is no need for repeaters to use this type of data in day-to-day operations. In this example, the other data 712 includes congestion data, and may include other data such as maintenance schedules, long-term reliability data, versioning data, weather data, reports of nearby disruptive activities, etc. In the example of FIG. 5, the operator station 505 could choose Beam Y, Y=4 if the operator considers load-balancing as higher priority than signal quality.

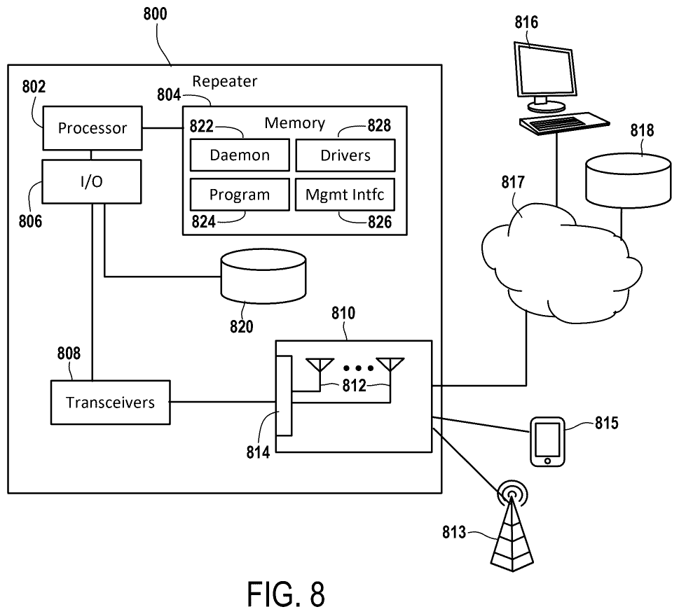

In FIG. 8, a block diagram shows components of a repeater 800 according to an example embodiment. The repeater 800 includes computing hardware such as a processor 802 (e.g., central processing unit or CPU), memory 804, and input/output (I/O) circuitry 806. The I/O circuitry 806 is coupled to radio transmission circuitry indicated here as one or more transceivers 808, which send and receive radio signals via an antenna system 810. The transceivers 808 may include amplifiers, preamplifiers, digital-to-analog converters (DAC), analog-to-digital converters (ADC), digital and analog filters, digital signal processors (DSPs), timing recovery processors, etc.

The antenna system includes antennas 812 and an electrical interface 814. Generally, at least one antenna 812 is a steerable, donor antenna operable to communicate with a base station 813 that provides a serving sector. The same or different antenna 812 operates as a repeating antenna (or serving antenna) which communicates with a terminal device 815. The repeater 800 provides network communications between the base station 813 and terminal 815, e.g., when the terminal 815 is located in a blind spot, radio blackout zone, or the like.

The antennas 812 also facilitate accessing a wide area network 817. Network elements such as an operator terminal 816 and remote data storage 818 are also coupled to and accessible via this network 817. The network 817 may include cellular provider's internal network, and/or the Internet. The repeater 800 is shown with its own data storage 820 which may be used in addition to or instead of the remote data storage 818.

The repeater 800 includes programs stored on the memory 804 with instructions executable by the CPU 802 and/or other processors. The repeater 800 may use a compact, embedded operating system (OS) such as Embedded Linux, NetBSD and the like, which are designed for organizing and controlling embedded hardware. In other embodiments, the repeater 800 may use a more full featured OS such as Linux, BSD Unix-based OS, etc., which run on more powerful processors that have features such as preemptive multitasking. Regardless of the OS used, the memory 804 will store instructions (e.g., programs, libraries, scripts) that perform primary repeater functions as well as the failover routines describe above. These instructions may be considered firmware and/or software.

In this example, the instructions includes one or more daemons 822 that continually run in the background and perform tasks related to relaying radio signals, system configuration, hardware control, power management, and the like. One or more programs 824 may be instantiated by one of the daemons 822 in order to perform a specific function, e.g., to perform scans as described in the diagram of FIG. 5. Both the daemons 822 and programs 824 may use drivers 828 that are designed for software/firmware control of specific hardware such as transceivers 808, storage 820, and network interfaces (not shown).

The instructions stored in memory 804 also include a management interface 826, which includes one or both of local and remote user interface functions that allows reading device status, changing device operation and configuration, power on and power off functions, etc. The repeater 800 may have limited user interface elements such as light emitting diodes (LEDs) that indicate status, however most user interface access will be provided by a locally connected device (e.g., via WiFi or serial port) and/or a remotely connected device such as operator terminal 816. The management interface 826 may include functions such as providing rendering information (e.g., HTML documents), managing connections (e.g., HTTP over TCP/IP), network discovery, etc.

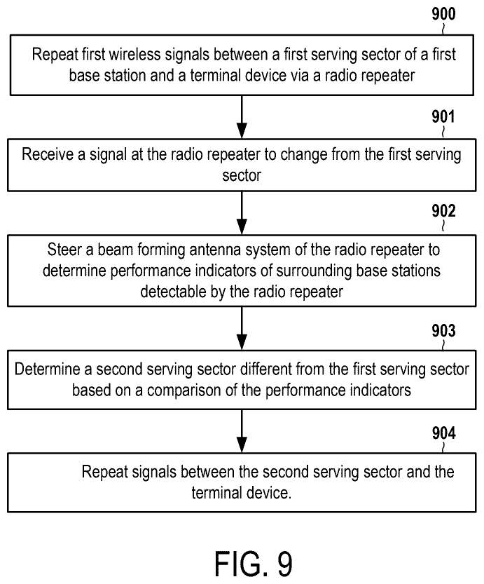

In FIG. 9, a flowchart shows a method according to an example embodiment. The method involves repeating 900 first wireless signals between a first serving sector of a first base station and a terminal device via a radio repeater. A signal is received 901 at the radio repeater to change from the first serving sector. A beamforming antenna system of the radio repeater is steered 902 to determine performance indicators of surrounding base stations detectable by the radio repeater. The repeater determines 903 second serving sector different from the first serving sector based on a comparison of the performance indicators. In response, the repeater is reconfigured to repeat 904 signals between the second serving sector and the terminal device.

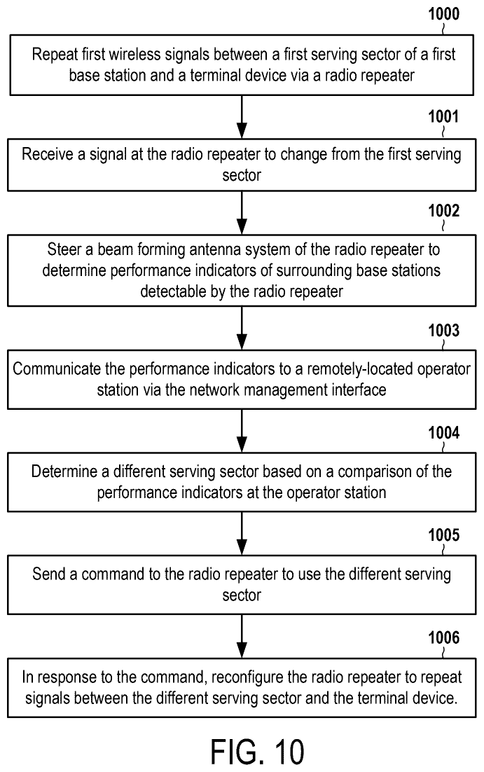

In FIG. 10, a flowchart shows a method according to another example embodiment. The method involves repeating 1000 first wireless signals between a first serving sector of a first base station and a terminal device via a radio repeater. A signal is received 1001 at the radio repeater to change from the first serving sector. A beamforming antenna system of the radio repeater is steered 1002 to determine performance indicators of surrounding base stations detectable by the radio repeater. The performance indicators are communicated 1003 (e.g., via a commonly accessible data storage unit, network message) to a remotely-located operator station via the network management interface. A different serving sector is determined 1004 based on a comparison of the performance indicators at the operator station. A command is sent 1005 to the radio repeater to use the different serving sector. In response to the command, the radio repeater is reconfigured 1006 to repeat signals between the different serving sector and the terminal device.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. A radio repeater, comprising:
a beamforming, antenna system coupled to communicate with a first serving sector of a first base station;
a radio transceiver operatively coupled to the antenna system and operable to relay signals between the first serving sector and a terminal device; and
a processor coupled to the radio transceiver and operable to:
receive a signal to change from the first serving sector;
steer the antenna system to determine performance indicators of surrounding base stations detectable by the radio repeater;
determine a second serving sector different from the first serving sector based on a comparison of the performance indicators; and
relay signals between the second serving sector and the terminal device.

2. The radio repeater of claim 1, further comprising a network management interface coupled to the processor, the processor further operable to communicate the performance indicators to a remotely-located operator station via the network management interface.

3. The radio repeater of claim 2, wherein the operator station is operable to:
determine additional network information about the surrounding base stations that is unavailable to the radio repeater;
based on the additional network information, determine a third serving sector different from the first and second serving sectors; and
send a command to the network management interface to use the third serving sector.

4. The radio repeater of claim 3, wherein the operator station comprises a user interface operable to display the additional network information and the performance indicators, wherein the third serving sector is determined by an operator and the command is triggered via an operator input to the user interface.

5. The radio repeater of claim 3, wherein the additional network information includes congestion information.

6. The radio repeater of claim 3, wherein the signal to change from the first serving sector is received at the network management interface.

7. The radio repeater of claim 3, wherein communicating the performance indicators to the operator station comprises storing the performance indicators on a data storage unit accessible by the operator station.

8. The radio repeater of claim 1, wherein the signal is an event indicating an unexpected outage affecting the first serving sector.

9. The radio repeater of claim 1, wherein the signal is a message indicating an expected outage affecting the first serving sector.

10. The radio repeater of claim 1, wherein the radio repeater provides cellular radio service to a region having a blind spot or coverage hole.

11. The radio repeater of claim 1, wherein the radio repeater provides high-availability cellular radio service to a region.

12. The radio repeater of claim 1, wherein the second serving sector is serviced by the first base station.

13. The radio repeater of claim 1, wherein the second serving sector is serviced by a second base station different from the first base station.

14. The radio repeater of claim 1, wherein the performance indicators comprises include two or more indicators selected from reference signal receive power (RSRP), reference signal receive quality (RSRQ), and signal to interference and noise ratio (SINR).

15. The radio repeater of claim 14, wherein determining the second serving sector based on the comparison of the performance indicators comprises a joint optimization based on the two or more indicators for each of the surrounding base stations.

16. The radio repeater of claim 15, wherein the joint optimization is based on a machine learning model that is trained using simulation data.

17. A method, comprising:
repeating first wireless signals between a first serving sector of a first base station and a terminal device via a radio repeater;
receiving a signal at the radio repeater to change from the first serving sector;
steering a beamforming antenna system of the radio repeater to determine performance indicators of surrounding base stations detectable by the radio repeater;
determining a second serving sector different from the first serving sector based on a comparison of the performance indicators; and
reconfiguring the radio repeater to repeat signals between the second serving sector and the terminal device.

18. The method of claim 17, further comprising communicating the performance indicators to a remotely-located operator station.

19. The method of claim 18, further comprising:
determining additional network information about the surrounding base stations that is unavailable to the radio repeater;
based on the additional network information, determining a third serving sector different from the first and second serving sectors; and
sending a command to the radio repeater to use the third serving sector.

20. The method of claim 19, further comprising:
displaying the additional network information and the performance indicators via a user interface facilitating operator selection of the third serving sector; and
triggering the command via an operator input to the user interface.

21. The method of claim 19, wherein the additional network information includes congestion information.

22. The method of claim 19, wherein communicating the performance indicators to the operator station comprises storing the performance indicators on a data storage unit accessible by the operator station.

23. The method of claim 17, wherein the signal is an event indicating an unexpected outage affecting the first serving sector.

24. The method of claim 17, wherein the signal is a message indicating an expected outage affecting the first serving sector.

25. The method of claim 17, wherein the radio repeater provides cellular radio service to a region having a blind spot or coverage hole.

26. The method of claim 17, wherein the radio repeater provides high-availability cellular radio service to a region.

27. The method of claim 17, wherein the second serving sector is serviced by the first base station.

28. The method of claim 17, wherein the second serving sector is serviced by a second base station different from the first base station.

29. The method of claim 17, wherein the performance indicators comprises include two or more indicators selected from reference signal receive power (RSRP), reference signal receive quality (RSRQ), and signal to interference and noise ratio (SINR).

30. The method of claim 29, wherein determining the second serving sector based on the comparison of the performance indicators comprises a joint optimization based on the two or more indicators for each of the surrounding base stations.

31. The method of claim 30, wherein the joint optimization is based on a machine learning model that is trained using simulation data.

32. A radio repeater, comprising:
a beamforming, antenna system coupled to communicate with a first serving sector of a first base station;
a radio transceiver operatively coupled to the antenna system and operable to relay signals between the first serving sector and a terminal device;
a network management interface coupled to a wide area network; and
a processor coupled to the radio transceiver and the network management interface, the processor operable to:
receive a signal to change from the first serving sector;
steer the antenna system to determine performance indicators of surrounding base stations detectable by the radio repeater;
communicate the performance indicators to a remotely-located operator station via the network management interface, a different serving sector being determined at the operator station based on a comparison of the performance indicators;
receive a command via the network management interface to use the different serving sector; and
in response to the command, reconfigure the transceiver to repeat signals between the different serving sector and the terminal device.

33. A method, comprising:
repeating first wireless signals between a first serving sector of a first base station and a terminal device via a radio repeater;
receiving a signal at the radio repeater to change from the first serving sector;
steering a beamforming antenna system of the radio repeater to determine performance indicators of surrounding base stations detectable by the radio repeater;
communicating the performance indicators to a remotely-located operator station via a wide-area network;
determining a different serving sector based on a comparison of the performance indicators at the operator station;
sending a command to the radio repeater to use the different serving sector; and
in response to the command, configuring the radio repeater to repeat signals between the different serving sector and the terminal device.

34. The method of claim 33, further comprising determining additional network information about the surrounding base stations that is unavailable to the radio repeater, wherein the determining of the different serving sector is further based on the additional network information.

35. The method of claim 33, further comprising:
displaying the performance indicators via a user interface facilitating operator selection of the different serving sector; and
triggering the command via an operator input to the user interface.
